(19) United States
(12) Patent Application Publication
(10) Pub. No.: US 2011/0222755 A1
(43) Pub. Date: Sep. 15, 2011

(54) DEVICE, METHOD AND COMPUTER READABLE MEDIUM FOR EVALUATING SHAPE OF OPTICAL ELEMENT

(75) Inventor: Shinji KIMURA, Saitama (JP)

(73) Assignee: HOYA CORPORATION, Tokyo (JP)

(21) Appl. No.: 13/093,163

(22) Filed: Apr. 25, 2011

(30) Foreign Application Priority Data
Mar. 9, 2010 (JP) 2011-051373
Apr. 28, 2010 (JP) 2010-102887

(51) Int. Cl. G06K 9/00

(52) U.S. Cl. 382/141

(57) ABSTRACT

A method for evaluating a shape of an optical element, including: executing polynomial approximation to obtain a deviation shape of a testing surface of an optical element with respect to an ideal surface; calculating an evaluation shape by extracting a rotationally symmetric irregularity component of the deviation shape from a result of the polynomial approximation; adding a 2^{nd} order component to the evaluation shape so that a region including a pupil center of the evaluation shape is planarized; and calculating a rotationally symmetric irregularity value of the testing surface based on the evaluation shape to which the 2^{nd} order component has been added.

### BACKGROUND OF THE INVENTION

The present invention relates to a method, a device and a computer readable medium for evaluating a surface of an optical element, and more specifically to a method, a device and a computer readable medium for quantitatively evaluating a processing error of a surface shape of an optical element by image analysis.

During a testing process of optical elements, evaluation values concerning the optical performance, such as a shape and the amount of aberration, are measured. For example, Japanese Patent Provisional Publication No. 2005-241592A (hereafter, referred to as JP2005-241592A) discloses an interference fringe analyzing device which obtains the amount of aberration from an interference fringe image. Specifically, the interference fringe analyzing device disclosed in JP2005-241592A is configured to simultaneously display an original image and an interference fringe image reconfigured with the amount of aberration obtained by analyzing the original image so as to enable a worker to easily understand the effectiveness of a measurement result.

In the testing process for a shape of an optical element, a deviation shape is measured with an interferometer or a shape measuring device. The measured deviation shape is evaluated by a comparison between a tolerance and a deviating amount with respect to an ideal shape (a design shape). When the deviating amount falls within the tolerance, the optical element is evaluated as a shape not having a processing error. When the deviating amount falls outside the tolerance, the optical element is evaluated as a shape having a processing error.

Let us consider a case where the surface shape tolerance is represented as “⅗(0.6)” in accordance with JIS (Japanese Industrial Standards). In this case, the surface shape needs to satisfy the precision that the surface shape corresponds to a code number 3, the sagitta error (Newton fringes) is five, and the wavefront irregularity is 0.6. The wavefront irregularity is one of evaluation values indicating the surface shape deviation. In general, the wavefront irregularity is known as a local distortion of Newton fringes (astigmatism, deformation (F)). In general, of wavefront irregularities, a rotationally symmetric wavefront irregularity is used for the shape evaluation for an optical element having rotational symmetry. There is a case where the rotationally symmetric wavefront irregularity is simply called a deformation.

There is a case where a relatively large deviation shape (e.g., sagging at the peripheral part) is locally caused on a testing surface of an optical element. In the shape evaluation by the rotationally symmetric wavefront irregularity, a defocus component corresponding to the approximation shape of the entire testing surface including the local deviation shape is added. FIG. 9 illustrates an example of the rotationally symmetric wavefront irregularity observed by an interferometer. A worker measures the presence/absence and the size of the processing error through the visual evaluation of the rotationally symmetric wavefront irregularity shown in FIG. 9. However, since as shown in FIG. 9 the interference fringe has a wavy pattern, it is difficult for the worker to read the deviating amount. Furthermore, since the rotationally symmetric wavefront irregularity is the deviating amount with respect to the above described approximation shape, the rotationally symmetric wavefront irregularity does not precisely represent the processing error of an actual product.

However, there is a problem that such a visual measurement involves a considerable amount of error. Furthermore, there is a problem that, when the interference fringe is to be adjusted, the error fluctuates depending on a degree of adjustment, and therefore the accuracy of the measurement decreases. There is also a problem that, when the deviation shape includes a rotationally asymmetric component, the degree of a curve of the interference fringe with respect to the adjustment varies depending on the rotationally asymmetric component, and thereby the measurement accuracy decreases.

FIGS. 2A and 2B are explanatory illustrations for explaining the problems of the visual measurement. Specifically, FIG. 2A illustrates a shape of a lens L (a spherical lens) to be inspected. In FIG. 2A, a lens surface indicated by a solid line is an actual shape of the lens L, and a lens surface indicated by a dashed line is an ideal shape. As shown in FIG. 2A, sagging by a transferring error is caused in the peripheral part of the lens L. FIG. 2B illustrates the interference fringe measured when the tilt component corresponding to approximately five fringes is applied to the lens L. The interference fringes I₁ to I₅ shown in FIG. 2B are respectively given different defocus components depending on the degree of adjustment. That is, as shown in FIG. 2B, the interference fringe changes depending on the degree of adjustment even when an identical subject is measured. If the interference fringe changes, the measured wavefront irregularity changes. As described above, the apparent wavefront irregularity changes depending on measurement conditions. Therefore, it is difficult to secure a high degree of reliability in the visual measurement.

### SUMMARY OF THE INVENTION

The present invention is advantageous in that it provides a method, a device and a computer readable medium capable of quantitatively and suitably evaluating a processing error of a surface of an optical element to be inspected.

According to an aspect of the invention, there is provided a method for quantitatively evaluating a processing error of a testing surface of an optical element, comprising: executing polynomial approximation to obtain a deviation shape of the testing surface with respect to an ideal surface; calculating an evaluation shape by extracting a rotationally symmetric irregularity component of the deviation shape from a result of the polynomial approximation; adding one of a 2^{nd} order component and a spherical component to the evaluation shape so that a region including a pupil center of the evaluation shape is deformed to be planar; and calculating the processing error of the testing surface based on the evaluation shape to which one of the 2^{nd} order component and the spherical component has been added.

With this configuration, since the interference fringe of which central region within the observation area is set to be linear can be tentatively obtained by adding one of the spherical component and the 2^{nd} order component to the evaluation shape formed by the rotationally symmetric irregularity component, it is possible to quantitatively obtain the deviating amount with respect to the paraxial spherical surface of the actual product shape (i.e., the amount representing more precisely representing the processing error of the actual product).

In at least one aspect, the method may further comprise: calculating a region which can be deformed to be planar on the evaluation shape, based on the rotationally symmetric irregularity component; and calculating one of the spherical component and the 2^{nd} order component required for deforming the calculated region to be planar. With this configuration, the processing error of the testing surface can be obtained with a high degree of precision.

In at least one aspect, a polynomial used for the polynomial approximation may be one of a Zernike polynomial and a rotationally symmetrical aspherical surface expression.

In at least one aspect, in the step of calculating the processing error, a PV (Peak to Valley) value of the evaluation shape to which one of the spherical component and the 2^{nd} order component has been added may be calculated, a rotationally symmetric irregularity to which one of the spherical component and the 2^{nd} order component has been added may be calculated by converting a unit of the PV value, and the processing error may be calculated from the rotationally symmetric irregularity.

In at least one aspect, the method may further comprise: judging whether the testing surface has a positive deformation or a negative deformation with respect to the ideal surface depending on a sign of the PV vale with reference to the region which has been deformed to be planar.

In at least one aspect, the method may further comprise: calculating the deviation shape using a measurement result of the testing surface by a predetermined measuring device.

According to another aspect of the invention, there is provided a computer readable medium having computer readable instruction stored thereon, which, when executed by a processor of a computer, configures the processor to perform the steps of: executing polynomial approximation to obtain a deviation shape of the testing surface with respect to an ideal surface; calculating an evaluation shape by extracting a rotationally symmetric irregularity component of the deviation shape from a result of the polynomial approximation; adding one of a 2^{nd} order component and a spherical component to the evaluation shape so that a region including a pupil center of the evaluation shape is deformed to be planar; and calculating the processing error of the testing surface based on the evaluation shape to which one of the 2^{nd} order component and the spherical component has been added.

With this configuration, since the interference fringe of which central region within the observation area is set to be linear can be tentatively obtained by adding one of the spherical component and the 2^{nd} order component to the evaluation shape formed by the rotationally symmetric irregularity component, it is possible to quantitatively obtain the deviating amount with respect to the paraxial spherical surface of the actual product shape (i.e., the amount representing more precisely representing the processing error of the actual product).

In at least one aspect, the instruction may further cause the processor to perform the steps of: calculating a region which can be deformed to be planar on the evaluation shape, based on the rotationally symmetric irregularity component; and calculating one of the spherical component and the 2^{nd} order component required for deforming the calculated region to be planar. With this configuration, the processing error of the testing surface can be obtained with a high degree of precision.

In at least one aspect, a polynomial used for the polynomial approximation may be one of a Zernike polynomial and a rotationally symmetrical aspherical surface expression.

In at least one aspect, in the step of calculating the processing error, a PV (Peak to Valley) value of the evaluation shape to which one of the spherical component and the 2^{nd} order component has been added may be calculated, a rotationally symmetric irregularity to which one of the spherical component and the 2^{nd} order component has been added may be calculated by converting a unit of the PV value, and the processing error may be calculated from the rotationally symmetric irregularity.

In at least one aspect, the instruction may further cause the processor to perform the step of: judging whether the testing surface has a positive deformation or a negative deformation with respect to the ideal surface depending on a sign of the PV vale with reference to the region which has been deformed to be planar.

In at least one aspect, the instruction may further cause the processor to perform the step of: calculating the deviation shape using a measurement result of the testing surface by a predetermined measuring device.

According to another aspect of the invention, there is provided a device for evaluating a shape of an optical element, comprising: a polynomial approximation unit configured to execute polynomial approximation to obtain a deviation shape of the testing surface with respect to an ideal surface; an evaluation shape calculation unit configured to calculate an evaluation shape by extract a rotationally symmetric irregularity component of the deviation shape from a result of the polynomial approximation; a component addition unit configured to add one of a 2^{nd} order component and a spherical component to the evaluation shape so that a region including a pupil center of the evaluation shape is deformed to be planar; and a processing error calculation unit configured to calculate the processing error of the testing surface based on the evaluation shape to which one of the 2^{nd} order component and the spherical component has been added.

With this configuration, since the interference fringe of which central region within the observation area is set to be linear can be tentatively obtained by adding one of the spherical component and the 2^{nd} order component to the evaluation shape formed by the rotationally symmetric irregularity component, it is possible to quantitatively obtain the deviating amount with respect to the paraxial spherical surface of the actual product shape (i.e., the amount representing more precisely representing the processing error of the actual product).

In at least one aspect, the device may further comprise: a region calculation unit configured to calculate a region which can be deformed to be planar on the evaluation shape, based on the rotationally symmetric irregularity component; and a component calculation unit configured to calculate one of the spherical component and the 2^{nd} order component required for deforming the calculated region to be planar. With this configuration, the processing error of the testing surface can be obtained with a high degree of precision.

In at least one aspect, a polynomial used for the polynomial approximation may be one of a Zernike polynomial and a rotationally symmetrical aspherical surface expression.

In at least one aspect, the processing error calculation unit may be configured to calculate a PV (Peak to Valley) value of the evaluation shape to which one of the spherical component and the 2^{nd} order component has been added, and to calculate the rotationally symmetric irregularity value by converting a unit of the PV value.

In at least one aspect, the device may further comprise: a judgment unit configured to judge whether the testing surface has a positive deformation or a negative deformation with respect to the ideal surface depending on a sign of the PV vale with reference to the region which has been deformed to be planar.

In at least one aspect, the device may further comprise: a deviation shape calculation unit configured to calculate the deviation shape using a measurement result of the testing surface by a predetermined measuring device.

### BRIEF DESCRIPTION OF THE ACCOMPANYING DRAWINGS

FIG. 1 is an explanatory illustration for explaining wavefront irregularity.

FIGS. 2A and 2B are explanatory illustrations for explaining problems of the visual measurement of the rotationally symmetric irregularity.

FIG. 3 is a block diagram generally illustrating a configuration of an optical element evaluation system according to an embodiment of the invention.

FIG. 4 is an explanatory illustration for visually showing that the spatial phase distribution includes various types of components.

FIG. 5 illustrates a deviation shape obtained as a result of analysis of an interference fringe image.

FIG. 6 illustrates a deviation shape calculated by using a coefficient of each term obtained by polynomial approximation.

FIG. 7 illustrates a spatial distribution of a defocus component to be added to the deviation shape shown in FIG. 6.

FIG. 8 illustrates a deviation shape of which central region is planarized.

FIG. 9 is an explanatory illustration for explaining the rotationally symmetric irregularity.

### DETAILED DESCRIPTION OF THE EMBODIMENTS

Hereinafter, an embodiment according to the invention is described with reference to the accompanying drawings. An actual product is produced such that a shape has a deviating amount falls within a tolerance with respect to an ideal shape. That is, a shape of an actual product (hereafter, referred to as an “actual product shape”) does not exactly coincide with the ideal shape. However, in this embodiment, the shape falling within the tolerance is regarded to be equivalent to the ideal shape not having a processing error. Since a testing surface of an optical element to be observed is processed with a high degree of precision, almost all of the entire region of the testing surface including an area around an optical axis is regarded as falling within the tolerance. Under such a premise, in this embodiment, the deviating amount with respect to a paraxial spherical surface of the actual product shape is measured and is subjected to image analysis so as to quantitatively evaluate the processing error.

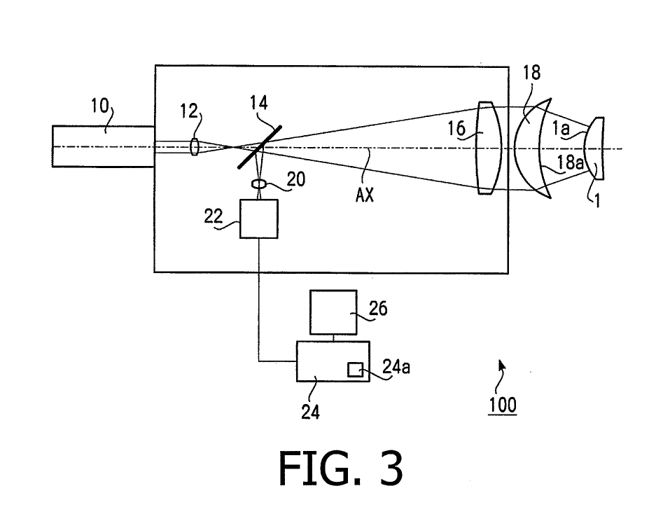

FIG. 3 is a block diagram generally illustrating a configuration of an optical element evaluation system 100 according to the embodiment of the invention. As shown in FIG. 3, the optical element evaluation system 100 includes a laser source 10 which emits a laser beam. The laser beam emitted by the laser source 10 is converged by a divergent lens 12 into a point source, and passes through a half mirror 14 as a diverging beam, and then is incident on a collimator lens 16. The laser beam is then converted by the collimator lens 16 into a collimated beam, and then is incident on a reference lens 18. A reference surface 18a of the reference lens 18 lets a part of the incident laser beam pass therethrough and lets the remaining part of the incident laser beam reflect therefrom.

A reference wavefront (reference wavefront light) reflected by the reference surface 18a is reflected by the half mirror 14, and is incident on an imaging lens 20. The reference wavefront light is incident on an imaging surface of an imaging camera 22 through the imaging lens is 20. A subject wavefront (subject wavefront light) which has passed through the reference surface 18a is made into a converging light beam by the reference lens 18, and is incident on a subject (lens) 1. The subject 1 is positioned such that the curvature of a testing surface 1a coincides with the curvature of the subject wavefront light. Adjustment for adjusting the position of the subject 1 as described above is referred to as “alignment”. The subject wavefront light is reflected by the testing surface 1a of the subject 1 and returns to the half mirror 14 along an optical path. The subject wavefront light is then reflected by the half mirror 14, and is incident on the imaging surface of the imaging camera 22 through the imaging lens 20. On the imaging surface of the imaging camera 22, the interference fringe is formed by interference between the reference wavefront light and the subject wavefront light. The interference light becomes bright when an optical path difference between the reference wavefront light and the subject wavefront light is equal to an integral multiple of the wavelength of the laser beam being used, and becomes dark when the optical path difference shifts by a half of the wavelength from an integral multiple of the wavelength. The interference fringe captured by the imaging camera 22 is displayed on a monitor 26 after being subjected to an image processing by an image processing apparatus 24. The image processing apparatus 24 may be a PC (Personal Computer) including a CPU (Central Processing Unit), a memory storing various types of data and programs, and a user interface.

The interference fringe displayed on the monitor 26 includes various types of components, such as a component caused by the alignment (a tilt component or a defocus component by the remaining alignment), a coma, astigmatism, a spherical aberration and high order aberrations. Therefore, it is difficult to measure the processing error with a high degree of precision by the visual measurement. For this reason, the optical element evaluation system 100 obtains the spatial phase distribution of the testing surface 1a by using a known interference fringe analyzing method, such as a fringe scanning method or a temporal phase shift method.

In this embodiment, an interference fringe analysis using the fringe scanning method is performed, for example. Specifically, a drive control unit (not shown) moves the reference lens 18 in a direction of an optical axis AX. As a result, the interval between the reference surface 18a and the testing surface 1a changes, and thereby the light and shade of the interference fringe periodically changes. The drive control unit moves the reference lens 18 so that the interference fringe changes by one cycle (2π). The image processing apparatus 24 captures a plurality of pieces of reference fringe image data while the reference lens 18 is moved, and calculates the initial phase based on the phase variation (the intensity variation) of each pixel on an interference fringe image. The image processing apparatus 24 obtains presence/absence of continuity between adjacent pixels and presence/absence of the phase shift corresponding to one cycle, in addition to the initial phase of each pixel, and associates them with information of each pixel. As a result, the spatial phase distribution of the testing surface 1a is obtained. The image processing apparatus 24 displays the obtained spatial phase distribution on the monitor 26 as a digital analysis result of the interference fringe. The obtained spatial phase distribution represents the deviation shape of the testing surface 1a.

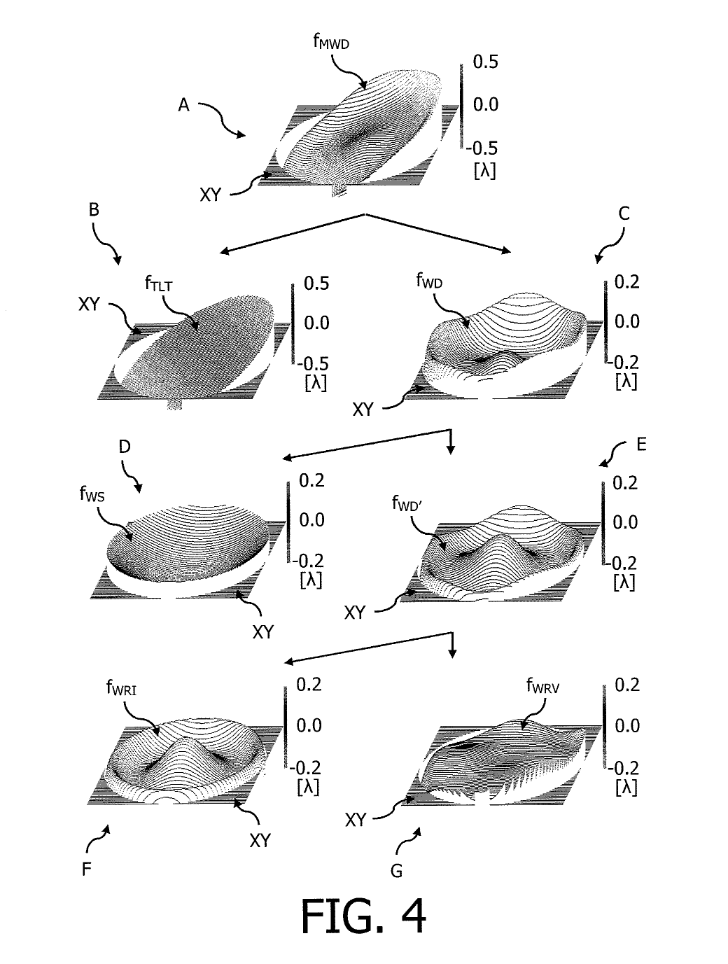

However, the spatial phase distribution still includes various types of components. FIG. 4 is an explanatory illustration for visually showing that the spatial phase distribution includes various types of components. The graphs (A to G) in FIG. 4 indicate the spatial distributions of respective components. In each graph, each component is represented by an amount with reference to X-Y plane.

Specifically, in FIG. 4, the graph A represents the deviation shape f_{MWD} obtained as a result of the interference fringe analysis. The deviation shape f_{MWD} can be decomposed into an average tilt component f_{TLT} (see graph B), which represents a lateral shift component, and a total component f_{WD} (see graph C) which represents the other components. The total component f_{WD} can be decomposed into a spherical component f_{WS} (see graph D), which represents a sagitta error, and an irregularity component f_{WD′} which (see graph E) represents the components other than the spherical component. The irregularity component f_{WD′}can be decomposed into a rotationally symmetric irregularity component f_{WRI} (see graph F) and a rotationally asymmetric irregularity component f_{WRV} (see graph G). As described above, the rotationally symmetric irregularity component f_{WRI} is included in the deviation shape f_{MWD}. In order to precisely evaluate the processing error of the testing surface 1a, it is necessary to extract the rotationally symmetric irregularity component f_{WRI} from the deviation shape f_{MWD}. For example, a polynomial is used for extracting the rotationally symmetric irregularity component f_{WRI}. In this embodiment, the rotationally symmetric irregularity component f_{WRI} is extracted by using, for example, Zernike polynomial.

In general, Zernike polynomial is developed in 36 terms. In Zernike polynomial, the rotationally symmetric irregularity component is represented with the 3^{rd} term, the 8^{th} term, the 15^{th} term, the 24^{th} term and the 35^{th} term indicated by the following expression (1). The 3^{rd} term represents the defocus component. The 8^{th} term, the 15^{th} term, the 24^{th} term and the 35^{th} term represent the 3^{rd} order, the 5^{th} order, the 7^{th} order and the 9^{th} order spherical aberrations, respectively.

$$\begin{matrix}Zer 3 & Defocus & 2 {r}^{2} - 1 \\ Zer 8 & SA 3 & 6 {r}^{4} - 6 {r}^{2} + 1 \\ Zer 15 & SA 5 & 20 {r}^{6} - 30 {r}^{4} + 12 {r}^{2} - 1 \\ Zer 24 & SA 7 & 70 {r}^{8} - 140 {r}^{6} + 90 {r}^{4} - 20 {r}^{2} + 1 \\ Zer 35 & SA 9 & 252 {r}^{10} - 630 {r}^{8} + 560 {r}^{6} - 210 {r}^{4} + 30 {r}^{2} - 1\end{matrix} \qquad ( 1 )$$

The deviation shape W(r) composed only of the rotationally symmetric irregularity component can be expressed by the following expression (2) which is obtained by multiplying each term n indicated in the expression (1) by a coefficient aₙ. A variable r in the expression (1) is a normalized value (0≦r≦1), and represents the pupil coordinate of the subject 1.

$$W ( r ) = {a}_{3} ( 2 {r}^{2} - 1 ) + {a}_{8} ( 6 {r}^{4} - 6 {r}^{2} + 1 ) + {a}_{15} ( 20 {r}^{6} - 30 {r}^{4} + 12 {r}^{2} - 1 ) + {a}_{24} ( 70 {r}^{8} - 140 {r}^{6} + 90 {r}^{4} - 20 {r}^{2} + 1 ) + {a}_{35} ( 252 {r}^{10} - 630 {r}^{8} + 560 {r}^{6} - 210 {r}^{4} + 30 {r}^{2} - 1 ) \qquad ( 2 )$$

Since the deviation shape W(r) includes a plurality of types of components, the deviation shape W(r) shows a complex shape. Therefore, depending on the amount of each component or the balance between components, there is a case where the deviation at the pupil center becomes large, as shown by the graph F in FIG. 4. When the deviation shape W(r) of the graph F is represented by the interference fringe, fringes distorted largely are observed in the central region of the observation area (as shown, for example, in FIG. 9). With regard to the deviation shape W(r) having such a distortion, it is still difficult to precisely evaluate the processing error.

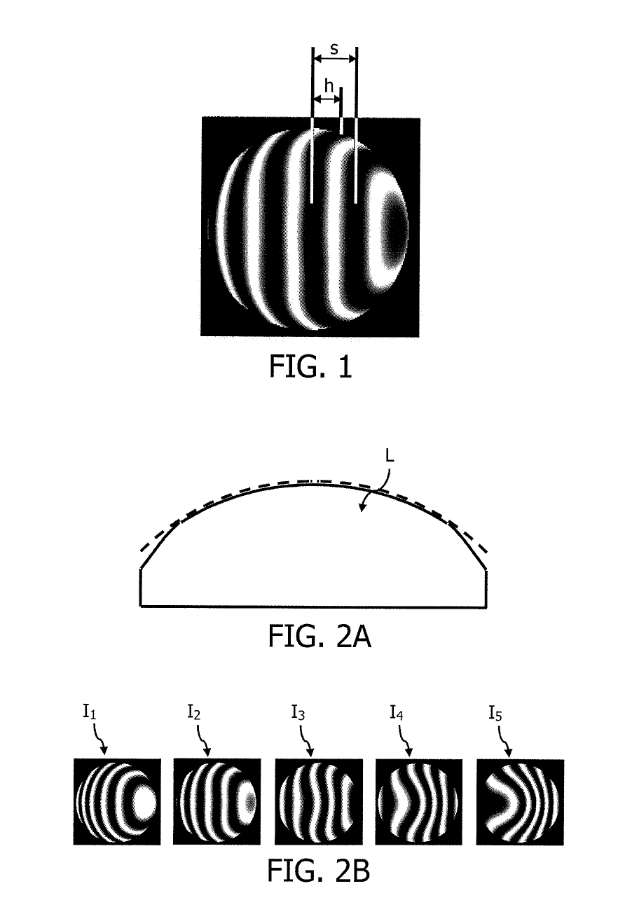

In order to precisely measure the processing error, it is preferable to add a defocus component corresponding to the actual product shape so that the interference fringe becomes linear in the central region of the observation area as shown, for example, in FIG. 1. In FIG. 1, a reference sign s represents the pitch of the interference fringe, and a reference sign h represents the deviation of the peripheral part with respect to the linear part in the interference fringe. “h/s” represents the deviation h with respect to the interference pitch s, and substantial represents the deviating mount with respect to the actual product shape.

For this reason, according to the embodiment, the image processing apparatus 24 executes a processing error calculation program 24a to execute a process (hereafter, referred to as a planarization process) in which the central region (a region including the pupil center) of the deviation shape W(r) is deformed to be planer so as to coincide with a reference plane (the X-Y plane in the example of FIG. 4). The deviation shape of the planarized region is equivalent to the linear reference fringe. That is, planarizing of the central region of the deviation shape W(r) is equivalent to executing an adjustment such that the interference fringe becomes linear in the central region of the observation area.

The processing error calculation program 24a adjusts the defocus component of the deviation shape W(r) to planarize the central region of the deviation shape W(r). As shown in the expressions (1) and (2), the defocus component is the 2^{nd} order component. Therefore, it is considered that, by setting all the 2^{nd} order components contained in the deviation shape W(r) to be zero, the central region is planarized and the liner interference fringe can be obtained. However, the deviation shape W(r) includes the high order components larger than or equal to 4^{th} order. Therefore, the interference fringe can not be set to be linear by merely setting the 2^{nd} order components to be zero. It should be noted that the defocus component may be set as a spherical component in place of the second order component.

The processing error calculation program 24a operates to planarize the central region by adjusting the 2^{nd} order components depending on the deviation shape W(r). Specifically, the processing error calculation program 24a obtains the pupil coordination rs at which the sign of the second derivative of the deviation shape W(r) changes first, starting from the starting point of the pupil coordinate 0 (W(0)). In a region of the pupil coordinate falling within the absolute value of the obtained value rs, the planarization can be executed. The second derivative of the deviation shape W(r) is shown in the following expression (3).

$$\frac{{\partial }^{2}}{\partial {r}^{2}} W ( r ) = 22680 {a}_{35} {r}^{8} + 3920 ( {a}_{24} - 9 {a}_{35} ) {r}^{6} + 600 ( {a}_{15} - 7 {a}_{24} + 28 {a}_{35} ) {r}^{4} + 72 ( {a}_{8} - 5 {a}_{15} + 15 {a}_{24} - 35 {a}_{35} ) {r}^{2} + 4 ( {a}_{3} - 3 {a}_{8} + 6 {a}_{15} - 10 {a}_{24} + 15 {a}_{35} ) {r}^{0} \qquad ( 3 )$$

Next, the 2^{nd} order component required for the planarization of the pupil coordinate region rs (i.e., the coefficient a3 which is the term of the defocus) is obtained. The following expression (4) is the first derivative of the deviation shape W(r). The following expression (5) is an expression obtained by decomposing the expression (4) into the spherical aberration component Wₛₐ and the defocus component W_{defo}.

$$\begin{matrix}\frac{\partial }{\partial r} W ( r ) = 2520 {a}_{35} {r}^{9} + 560 ( {a}_{24} - 9 {a}_{35} ) {r}^{7} + 120 ( {a}_{15} - 7 {a}_{24} + 28 {a}_{35} ) {r}^{5} + 24 ( {a}_{8} - 5 {a}_{15} + 15 {a}_{24} - 35 {a}_{35} ) {r}^{3} + 4 ( {a}_{3} - 3 {a}_{8} + 6 {a}_{15} - 10 {a}_{24} + 15 {a}_{35} ) r & ( 4 ) \\ \frac{\partial }{\partial r} {W}_{sa} ( r ) = 2520 {a}_{35} {r}^{9} + 560 ( {a}_{24} - 9 {a}_{35} ) {r}^{7} + 120 ( {a}_{15} - 7 {a}_{24} + 28 {a}_{35} ) {r}^{5} + 24 ( {a}_{8} - 5 {a}_{15} + 15 {a}_{24} - 35 {a}_{35} ) {r}^{3} + 4 ( - 3 {a}_{8} + 6 {a}_{15} - 10 {a}_{24} + 15 {a}_{35} ) r \\ \frac{\partial }{\partial r} {W}_{defo} ( r ) = 4 {a}_{3} r & ( 5 )\end{matrix}$$

The processing error calculation program 24a calculates the coefficient a3 by which the first derivative of the deviation shape W(r) is minimized (i.e., the adjusting amount of the 2^{nd} order components required for the planarization), by using the least squares approximation.

$$\begin{matrix} \frac{\partial }{\partial r} W ( r ) = {W}^{′} ( r ) = {W}_{sa}^{′} ( r ) + {W}_{defo}^{′} ( r ) & ( 6 ) \\ {W}^{′2} ( r ) = {W}_{sa}^{′2} ( r ) + 2 {W}_{sa}^{′} ( r ) \cdot {W}_{defo}^{′} ( r ) + {W}_{defo}^{′2} ( r ) & ( 7 ) \\ {\sum }_{{r}_{i} = 0}^{{r}_{s}} {W}^{′2} ( {r}_{i} ) = {\sum }_{{r}_{i} = 0}^{{r}_{s}} {W}_{sa}^{′2} ( {r}_{i} ) + 2 {\sum }_{{r}_{i} = 0}^{{r}_{s}} \{ {W}_{sa}^{′} ( {r}_{i} ) \cdot {W}_{defo}^{′} ( {r}_{i} ) \} + {\sum }_{{}_{i}^{}{r}{}_{i}^{} = 0}^{{r}_{s}} {W}_{defo}^{′2} ( {r}_{i} ) & ( 8 ) \\ \frac{\partial }{\partial {a}_{3}} {\sum }_{{r}_{i} = 0}^{{r}_{s}} {W}^{′2} ( {r}_{i} ) = 8 {\sum }_{{r}_{l} = 0}^{{r}_{s}} \{ {W}_{sa}^{′} ( {r}_{i} ) \cdot {r}_{i} \} + 32 {a}_{3} {\sum }_{{r}_{i} = 0}^{{r}_{s}} {r}_{i}^{2} = 0 & ( 9 ) \\ {a}_{3} = - \frac{{\sum }_{{r}_{i} = 0}^{{r}_{s}} \{ {W}_{sa}^{′} ( {r}_{i} ) \cdot {r}_{i} \}}{4 {\sum }_{{r}_{i} = 0}^{{r}_{s}} {r}_{i}^{2}} & ( 10 )\end{matrix}$$

The processing error calculation program 24a obtains a PV (Peak to Valley) value of the deviation shape W(r) by assigning the calculated coefficient a3 to the expression (2) (i.e., by planarizing the pupil coordinate region rs by adding the 2^{nd} order component to the deviation shape W(r)). The PV value (unit: X) represents an optical path difference at the pupil coordinate (e.g., r≈1) at which the deviation is maximized when W(0)=0. The sign of the PV value is defined with reference to the planarized pupil coordinate region rs. The PV value takes a negative value when the actual product shape has a negative deformation (i.e., a recessed part of the deviation shape with respect to the paraxial spherical surface of the actual product shape (e.g., sagging)), and takes a positive value when the actual product shape has a positive deformation (a protruded part of the deviation shape with respect to the paraxial spherical surface of the actual product shape (e.g., a turned-up part)). The processing error calculation program 24a judges whether the sagging or the turn-up part (or a deviation shape of some kind caused by a processing error, including sagging or the turned-up part) is caused on the testing surface 1a depending on the sign of the PV value, and displays a judgment result on the monitor 26.

The processing error calculation program 24a executes conversion of the unit of the PV value (2) to convert the PV value into the deviation observed as the interference fringe (i.e., the rotationally symmetric irregularity Ne to which the second component has been added (represented as h/s)). Specifically, using the following expression (11), the processing error calculation program 24a executes the wavelength conversion while defining the PV value as the round-trip optical path length (i.e., doubling), and calculates the rotationally symmetric irregularity Ne to which the second component has been added. The reason why the PV value is defined as the round-trip value is that the visually observed interference fringe corresponds to the round-trip optical path length of the deviation. It should be noted that λ_{inf} is the wavelength of the laser beam emitted from the laser source 10, and is, for example, 632.8 nm λₑ is an evaluation wavelength defined in JIS, and is, for example, 546.1 nm. The thus calculated rotationally symmetric irregularity Ne to which the second component has been added represents quantitatively the processing error with respect to the paraxial spherical surface of the actual product shape.

$${N}_{e} = W [ pv λ ] \times 2 \times \frac{{λ}_{inf}}{{λ}_{e}} \qquad ( 11 )$$

As described above, according to the optical element evaluation system 100 of the embodiment, the interference fringe which becomes liner in the central region within the observation area is tentatively obtained, and the PV value corresponding to the deviation h (see FIG. 1) is calculated. Then, the rotationally symmetric irregularity Ne (i.e., the deviating amount of the actual product shape with respect to the paraxial spherical shape) is calculated. Since the substantial deviating amount with respect to the actual product shape is calculated, the processing error can be obtained with a high degree of precision. That is, since the processing error can be precisely quantified while calculating the deviating amount with little noise (with respect to the paraxial spherical surface of the actual product shape) by adding an appropriate amount of second order component, it becomes possible to solve the above described problems in the conventional method where the rotationally symmetric irregularity shown in FIG. 9 is evaluated as the processing error. It is also possible to solve the problem concerning lack of accuracy in the visual observation.

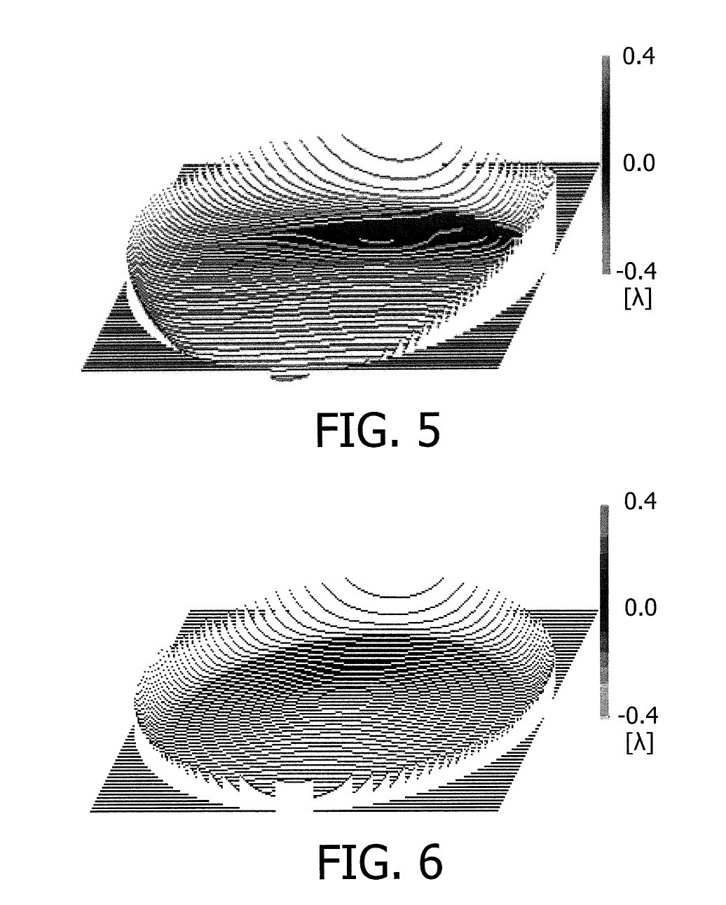

Next, a concrete example (a first example) is explained. The quantitative measurement of the processing error in the first example is visually illustrated in the spatial distribution diagrams of FIGS. 5 to 8.

FIG. 5 is a graph illustrating the deviation shape corresponding to the graph A in FIG. 4. The coefficient (λ) of each term obtained by executing the polynomial approximation for the deviation shape shown in FIG. 5 is indicated below.
a₄=0.81, a₅=−0.028, a₆=−0.006, a₇=0.035, a₈=0.061, a₉=0.011, . . . , a₁₅=0.037, . . . , a₂₄=−0.026, . . . , a₃₅=−0.010

The 3^{rd} term obtained by executing the polynomial approximation is the defocus component caused by the remaining alignment during the measurement. In the first example, the defocus component caused by the remaining alignment is not considered (i.e., a₃=0) for the purpose of clarifying the feature of the invention.

FIG. 6 is a graph illustrating the rotationally symmetric irregularity (corresponding to the graph F in FIG. 4) reconfigured with the above described coefficients a₈, a₁₅, a₂₄ and a₃₅. As shown in FIG. 6, the deviation shape W(r) composed only of the rotationally symmetric irregularity is formed such that the central region is gently lifted up toward the pupil center. That is, when viewed as the interference fringe, the central region of the deviation shape W(r) is not liner because the deviation shape W(r) includes the high order components larger than or equal to 4^{th} order. In order to measure the processing error with a high degree of precision, the planarization is executed by the processing error calculation program 24a.

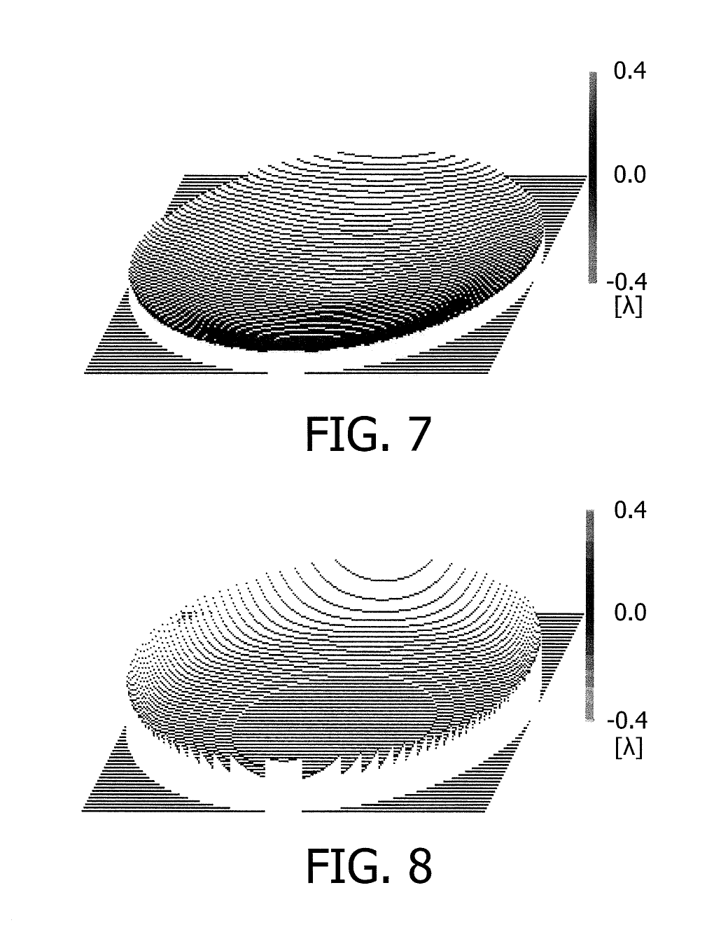

When the pupil coordinate rs of the deviation shape W(r) of FIG. 6 is calculated, rs=0.22 is obtained. That is, in the first example, the pupil coordinate region rs of the pupil coordinate of −0.22 to 0.22 is a region which can be planarized. When the 2^{nd} order component required for the planarization of the pupil coordinate region rs (i.e., the coefficient a of the term of the defocus) is calculated by the expression (10), a₃=0.086 is obtained. The spatial distribution of the 2^{nd} order component defined when a3=0.086 is shown in FIG. 7.

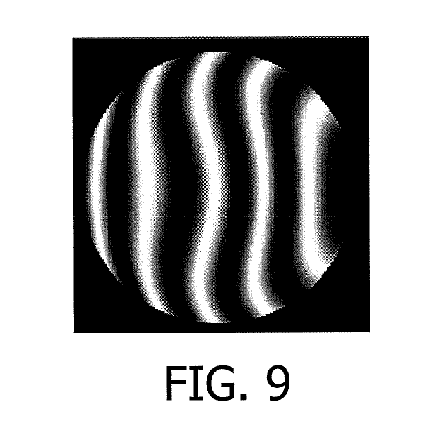

The processing error calculation program 24a assigns the calculated coefficient a₃ to the expression (2). That is, the processing error calculation program 24a adds together the deviation shape W(r) and the 2^{nd} order component shown in FIG. 7. Then, as shown in FIG. 8, the central region (−0.22≦rs≦0.22) of the deviation shape W(r) is planarized. When the PV value of the deviation shape W(r) is calculated, PV=0.250(λ) is obtained. When the unit of the PV value is converted by the following expression (11), the rotationally symmetric irregularity Ne=0.6 to which the 2^{nd} order component has been added is obtained. That is, since, in the first example, the deviating amount with respect to the paraxial spherical surface of the actual product shape is precisely calculated without an error by visual measurement, the processing error can be quantitatively measured.

Although the present invention has been described in considerable detail with reference to certain preferred embodiments thereof, other embodiments are possible. For example, the shape of the testing surface 1a may be measured with a contact-type or non-contact type three dimensional scanning shape measurement device in place of the interferometer.

In the above described embodiment, Zernike polynomial is used. However, in another embodiment, another type of polynomial may be used. For example, a rotationally symmetric aspherical surface expression may be used. In this case, the deviation shape W(r) composed only of the rotationally symmetric irregularity is represented by the following expression (12). In the expression (12), the deviation shape W(r) is expressed by components up to 10^{th} order for the sake of simplicity.

W(r)=A₂r²+A₄r⁴+A₆r⁶+A₈r⁸+A₁₀r¹⁰ (¹²)

The following expression (13) represents the second derivative of the deviation shape W(r) for obtaining the pupil coordinate region rs. The following expression (14) represents the first derivative of the deviation shape W(r) for obtaining the 2^{nd} order component required for planarization of the pupil coordinate region rs. In the following expression (15), the expression (14) is decomposed into the 2^{nd} order component W₂ and the high order components Wₕ larger than 2^{nd} order.

$$\begin{matrix}\frac{{\partial }^{2}}{\partial {r}^{2}} W ( r ) = 2 {A}_{2} + 12 {A}_{4} {r}^{2} + 30 {A}_{6} {r}^{4} + 56 {A}_{8} {r}^{6} + 80 {A}_{10} {r}^{8} & ( 13 ) \\ \frac{\partial }{\partial r} W ( r ) = 2 {A}_{2} r + 4 {A}_{4} {r}^{3} + 6 {A}_{6} {r}^{5} + 8 {A}_{8} {r}^{7} + 10 {A}_{10} {r}^{9} & ( 14 ) \\ \frac{\partial }{\partial r} {W}_{h} ( r ) = 4 {A}_{4} {r}^{3} + 6 {A}_{6} {r}^{5} + 8 {A}_{8} {r}^{7} + 10 {A}_{10} {r}^{9} & \\ \frac{\partial }{\partial r} {W}_{2} ( r ) = 2 {A}_{2} r & ( 15 )\end{matrix}$$

The processing error calculation program 24a calculates the coefficient A₂ by which the first derivative of the deviation shape W(r) is minimized within the range 0<r<rs (i.e., the adjusting amount of the 2^{nd} order component required for the planarization), by using the least-squares approximation. By assigning the calculated coefficient A₂ to the expression (12), the PV value of the deviation shape W(r) is obtained. By converting the PV value into the wavelength, the rotationally symmetric irregularity Ne to which the 2^{nd} order component has been added is obtained as in the case of Zernike polynomial.

$$\begin{matrix}\frac{\partial }{\partial r} W ( r ) = {W}^{′} ( r ) = {W}_{h}^{′} ( r ) + {W}_{2}^{′} ( r ) & ( 16 ) \\ {W}^{′2} ( r ) = {W}_{h}^{′2} ( r ) + 2 {W}_{h}^{′} ( r ) \cdot {W}_{h}^{′} ( r ) + {W}_{2}^{′2} ( r ) & ( 17 ) \\ {\sum }_{{r}_{i} = 0}^{{r}_{s}} {W}^{′2} ( {r}_{i} ) = {\sum }_{{r}_{i} = 0}^{{r}_{s}} {W}_{h}^{′2} ( {r}_{i} ) + 2 {\sum }_{{r}_{i} = 0}^{{r}_{s}} \{ {W}_{h}^{′} ( {r}_{i} ) \cdot {W}_{2}^{′} ( {r}_{i} ) \} + {\sum }_{{r}_{i} = 0}^{{r}_{s}} {W}_{2}^{′2} ( {r}_{i} ) & ( 18 ) \\ \frac{\partial }{\partial {A}_{2}} {\sum }_{{r}_{i} = 0}^{{r}_{s}} {W}^{′2} ( {r}_{i} ) = 4 {\sum }_{{r}_{i} = 0}^{{r}_{s}} \{ {W}_{h}^{′} ( {r}_{i} ) \cdot {r}_{i} \} + 8 {A}_{3} {\sum }_{{r}_{i} = 0}^{{r}_{s}} {r}_{i}^{2} = 0 & ( 19 ) \\ {A}_{2} = - \frac{{\sum }_{{r}_{i} = 0}^{{r}_{s}} \{ {W}_{h}^{′} ( {r}_{i} ) \cdot {r}_{i} \}}{2 {\sum }_{{r}_{i} = 0}^{{r}_{s}} {r}_{i}^{2}} & ( 20 )\end{matrix}$$

This application claims priority of Japanese Patent Applications No. P2010-102887, filed on Apr. 28, 2010, and No. P2011-51373, file on March 9, 2011. The entire subject matter of the applications is incorporated herein by reference.

What is claimed is:

1. A method for quantitatively evaluating a processing error of a testing surface of an optical element, comprising:
executing polynomial approximation to obtain a deviation shape of the testing surface with respect to an ideal surface;
calculating an evaluation shape by extracting a rotationally symmetric irregularity component of the deviation shape from a result of the polynomial approximation;
adding one of a 2^{nd} order component and a spherical component to the evaluation shape so that a region including a pupil center of the evaluation shape is deformed to be planar; and
calculating the processing error of the testing surface based on the evaluation shape to which one of the 2^{nd} order component and the spherical component has been added.

2. The method according to claim 1,
further comprising:
calculating a region which can be deformed to be planar on the evaluation shape, based on the rotationally symmetric irregularity component; and
calculating one of the spherical component and the 2^{nd} order component required for deforming the calculated region to be planar.

3. The method according to claim 1,
wherein a polynomial used for the polynomial approximation is one of a Zernike polynomial and a rotationally symmetrical aspherical surface expression.

4. The method according to claim 1,
wherein, in the step of calculating the processing error, a PV (Peak to Valley) value of the evaluation shape to which one of the spherical component and the 2^{nd} order component has been added is calculated, a rotationally symmetric irregularity to which one of the spherical component and the 2^{nd} order component has been added is calculated by converting a unit of the PV value, and the processing error is calculated from the rotationally symmetric irregularity.

5. The method according to claim 4,
further comprising:
judging whether the testing surface has a positive deformation or a negative deformation with respect to the ideal surface depending on a sign of the PV vale with reference to the region which has been deformed to be planar.

6. The method according to claim 1,
further comprising:
calculating the deviation shape using a measurement result of the testing surface by a predetermined measuring device.

7. A computer readable medium having computer readable instruction stored thereon, which, when executed by a processor of a computer, configures the processor to perform the steps of:
executing polynomial approximation to obtain a deviation shape of the testing surface with respect to an ideal surface;
calculating an evaluation shape by extracting a rotationally symmetric irregularity component of the deviation shape from a result of the polynomial approximation;
adding one of a 2^{nd} order component and a spherical component to the evaluation shape so that a region including a pupil center of the evaluation shape is deformed to be planar; and
calculating the processing error of the testing surface based on the evaluation shape to which one of the 2^{nd} order component and the spherical component has been added.

8. The computer readable medium according to claim 7, wherein the instruction further causes the processor to perform the steps of:
calculating a region which can be deformed to be planar on the evaluation shape, based on the rotationally symmetric irregularity component; and
calculating one of the spherical component and the 2^{nd} order component required for deforming the calculated region to be planar.

9. The computer readable medium according to claim 7,
wherein a polynomial used for the polynomial approximation is one of a Zernike polynomial and a rotationally symmetrical aspherical surface expression.

10. The computer readable medium according to claim 7,
wherein, in the step of calculating the processing error, a PV (Peak to Valley) value of the evaluation shape to which one of the spherical component and the 2^{nd} order component has been added is calculated, a rotationally symmetric irregularity to which one of the spherical component and the 2^{nd} order component has been added is calculated by converting a unit of the PV value, and the processing error is calculated from the rotationally symmetric irregularity.

11. The computer readable medium according to claim 10, wherein the instruction further causes the processor to perform the step of:
judging whether the testing surface has a positive deformation or a negative deformation with respect to the ideal surface depending on a sign of the PV vale with reference to the region which has been deformed to be planar.

12. The computer readable medium according to claim 7, wherein the instruction further causes the processor to perform the step of:
calculating the deviation shape using a measurement result of the testing surface by a predetermined measuring device.

13. A device for evaluating a shape of an optical element, comprising:
a polynomial approximation unit configured to execute polynomial approximation to obtain a deviation shape of the testing surface with respect to an ideal surface;
an evaluation shape calculation unit configured to calculate an evaluation shape by extracting a rotationally symmetric irregularity component of the deviation shape from a result of the polynomial approximation;
a component addition unit configured to add one of a 2^{nd} order component and a spherical component to the evaluation shape so that a region including a pupil center of the evaluation shape is deformed to be planar; and
a processing error calculation unit configured to calculate the processing error of the testing surface based on the evaluation shape to which one of the 2^{nd} order component and the spherical component has been added.

14. The device according to claim 13,
further comprising:
a region calculation unit configured to calculate a region which can be deformed to be planar on the evaluation shape, based on the rotationally symmetric irregularity component; and
a component calculation unit configured to calculate one of the spherical component and the 2^{nd} order component required for deforming the calculated region to be planar.

15. The device according to claim 13,
wherein a polynomial used for the polynomial approximation is one of a Zernike polynomial and a rotationally symmetrical aspherical surface expression.

16. The device according to claim 13,
wherein the processing error calculation unit is configured to calculate a PV (Peak to Valley) value of the evaluation shape to which one of the spherical component and the 2^{nd} order component has been added, and to calculate the rotationally symmetric irregularity value by converting a unit of the PV value.

17. The device according to claim 16, further comprising:
a judgment unit configured to judge whether the testing surface has a positive deformation or a negative deformation with respect to the ideal surface depending on a sign of the PV vale with reference to the region which has been deformed to be planar.

18. The device according to claim 13, further comprising:
a deviation shape calculation unit configured to calculate the deviation shape using a measurement result of the testing surface by a predetermined measuring device.
